(19) United States
(12) Patent Application Publication
(10) Pub. No.: US 2025/0166600 A1
(43) Pub. Date: May 22, 2025

(54) PERSONALIZED SERVICE PROVISIONING WITH CONTEXTUAL AWARENESS

(71) Applicant: Vidi Labs Limited, Tsim Sha Tsui (HK)

(72) Inventors: Turzo Bose, Kowloon Tong (HK); Reshika Palaniyappan Velumani, Kowloon Tong (HK)

(21) Appl. No.: 18/955,833

(22) Filed: Nov. 21, 2024

Related U.S. Application Data
(60) Provisional application No. 63/602,205, filed on Nov. 22, 2023.
(60) Provisional application No. 63/602,199, filed on Nov. 22, 2023.
(60) Provisional application No. 63/602,201, filed on Nov. 22, 2023.

(51) Int. Cl. G10L 13/02; G06V 10/70; G06V 20/52; G06V 20/62

(52) U.S. Cl. CPC G10L 13/02; G06V 10/768; G06V 20/52; G06V 20/63

(57) ABSTRACT

Systems, devices, and methods related to provisioning services to a user are provided. An example of a user device worn by a visually impaired user is configured to obtain an image of a current scene surrounding the user, identify an object in the image, detect a plurality of texts associated with the object, detect a plurality of visual features and semantic features related to the text, determine an identity of the object and one or more attributes of the object based at least in part on the visual features and the semantic features, select one or more texts for presentation from the plurality of texts, and present the selected texts in an audio form to the user to allow the user to perceive the identity and one or more attributes of the object.

### CROSS-REFERENCES TO RELATED APPLICATIONS

This Non-Provisional application claims the benefit of U.S. Provisional Application No. 63/602, 199 filed on Nov. 22, 2023, entitled “PERSONALIZED SERVICE PROVISIONING,” U.S. Provisional Application No. 63/602,205, filed on Nov. 22, 2023, entitled “PROVISIONING CONTEXTUAL INFORMATION AND PERSONALIZED TRANSPORTATION GUIDANCE,” U.S. Provisional Application No. 63/602,201, filed on

Nov. 22, 2023, entitled “PERSONALIZED SERVICE PROVISIONING WITH CONTEXTUAL AWARENESS,” the entire contents of which are incorporated herein by reference.

### BACKGROUND

In the field of assistance technology, there exists a longstanding need for providing effective service, guidance, and support to users having special needs, such as visually impaired individuals and elderly users, particularly in dynamic and complex environments. Traditional approaches to fulfilling this need have predominantly relied on static and one-size-fits-all solutions, which often lack real-time adaptability and personalization. These conventional methods have left many users without access to the dynamic service required for a rapidly changing world. For example, one common traditional approach is the use of pre-recorded audio guides in public or private spaces. These guides provide a fixed set of instructions, regardless of an individual's specific location, surroundings, interests, preferences, or needs. As a result, they fall short of delivering the level of dynamic and personalized support.

### SUMMARY

In accordance with some embodiments of the present disclosure, a method is provided. In one example, a method is performed by a user device worn by a user and includes obtaining an image of a current scene surrounding the user, identifying an object in the image, detecting a plurality of texts associated with the object, detecting a plurality of visual features and semantic features related to the text, determining an identity of the object and one or more attributes of the object based at least in part on the visual features and the semantic features, selecting one or more texts for presentation from the plurality of texts, and presenting the selected texts in an audio form to the user to allow the user to perceive the identity and one or more attributes of the object.

In accordance with some embodiments of the present disclosure, a user device is provided. In one example, the user device includes: one or more processors and a computer-readable storage media storing computer-executable instructions. The computer-executable instructions, when executed by the one or more processors, cause the user device to obtain an image of a current scene surrounding the user, identify an object in the image, detect a plurality of texts associated with the object, detect a plurality of visual features and semantic features related to the text, determine an identity of the object and one or more attributes of the object based at least in part on the visual features and the semantic features, select one or more texts for presentation from the plurality of texts, and present the selected texts in an audio form to the user to allow the user to perceive the identity and one or more attributes of the object.

In accordance with some embodiments of the present disclosure, a system is provided. In one example, the system includes: a user device and a central server in communication with the user device via a network. In some embodiments, the central server is a cloud-based server, and the network is a high-speed wireless network. The user device is configured to obtain an image of a current scene surrounding the user and transmit the image to the central server. The real-time user data comprising current location information of the user. The central server is configured to identify an object in the image, detect a plurality of texts associated with the object, detect a plurality of visual features and semantic features related to the text, determine an identity of the object and one or more attributes of the object based at least in part on the visual features and the semantic features, select one or more texts for presentation from the plurality of texts, and transmit the selected texts to the user device. The user device is further configured to present the selected texts in an audio form to the user.

In accordance with some embodiments, the present disclosure also provides a non-transitory machine-readable storage medium encoded with instructions, the instructions executable to cause one or more electronic processors of a computer system or computer device to perform any one of the methods or processes described in the present disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A is a schematic diagram illustrating an example of a communications system, according to various embodiments of the present disclosure.

FIG. 1B is a schematic diagram illustrating another example of a communications system, according to various embodiments of the present disclosure.

FIG. 2 is a flow diagram illustrating an example method for providing service to a user, according to various embodiments of the present disclosure.

FIG. 3 is a flow diagram illustrating an example method for recognizing an object from an image of a scene, according to various embodiments of the present disclosure.

FIG. 4 is a flow diagram illustrating an example process for scene recognition, according to various embodiments of the present disclosure.

FIG. 5 is a flow diagram illustrating an example process of depth/distance determination, according to various embodiments of the present disclosure.

FIG. 6 is a flow diagram illustrating an example process for vehicle detection and transportation assistance, according to various embodiments of the present disclosure.

FIG. 7 is a flow diagram illustrating an example method for provisioning transportation assistance and guidance to a user in need thereof, according to various embodiments of the present disclosure.

FIG. 8 is a flow diagram illustrating another example method for provisioning guidance to a user in need thereof for the user to perceive scene context, according to various embodiments of the present disclosure.

FIG. 9 illustrates an example user interface of the service provisioning device of FIGS. 1A and 1B, according to various embodiments of the present disclosure.

FIG. 10 is a schematic block diagram illustrating an example computer system or computer device, according to various embodiments of the present disclosure.

### DETAILED DESCRIPTION

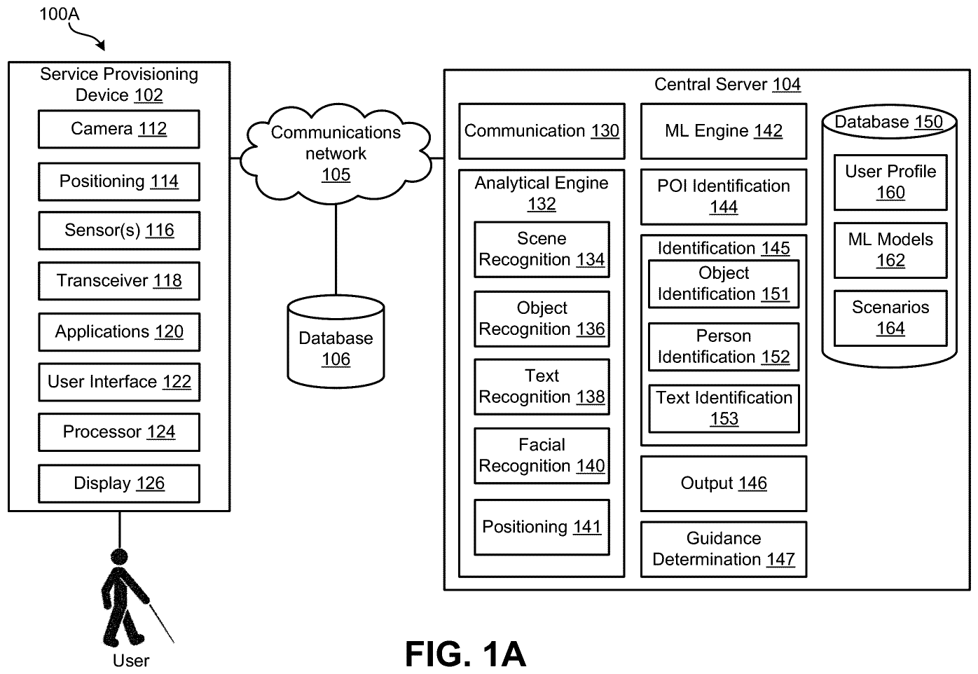

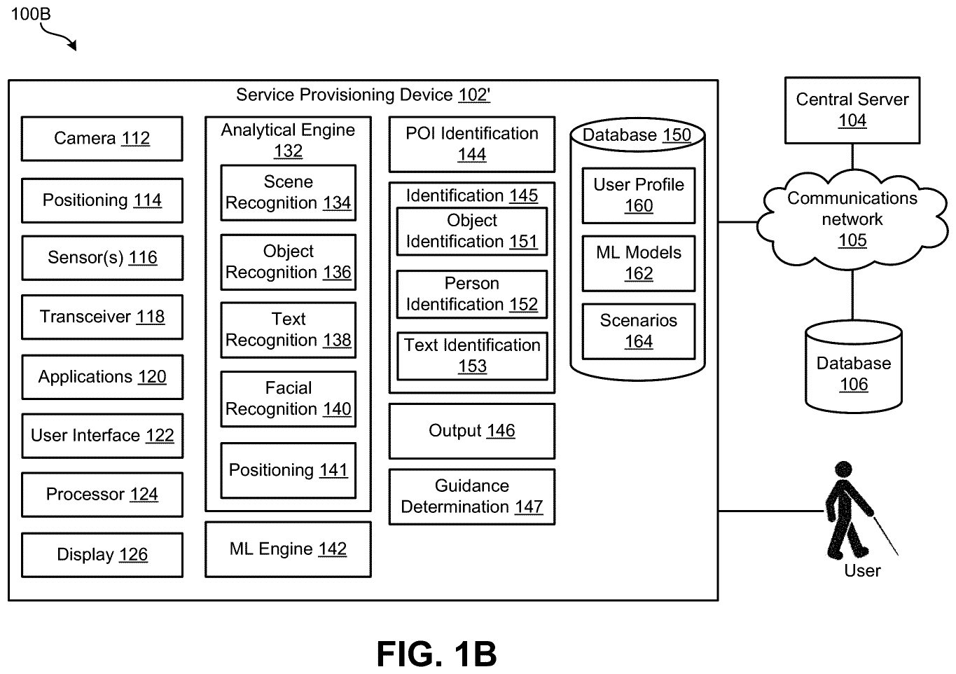

FIG. 1A is a schematic diagram illustrating an example communications system 100A (hereinafter “system 100A”) for monitoring surroundings of a user and provisioning personalized and adaptive service/guidance to the user, according to various embodiments. In the illustrated example, system 100A includes, among other components, a service provisioning device 102, a central server 104, a communications network 105, and a database 106. Each component may include a software component, a hardware component, or a combination of both. Various components included in system 100A are communicatively connected to each other via the communications network 105. In some embodiments, additional or few components may be included.

The service provisioning device 102 is a lightweight and compact user device wearable by a user in need of service, assistance, or guidance. The user may be a visually impaired person, an elderly person, a person having mobility impairments, a person having cognitive disabilities, and so on. The service provisioning device 102 is designed to be adaptable and can be worn on various body parts to cater to the diverse needs and preferences of users. For example, the service provisioning device 102 can be placed on the head, like a headband or attached to eyewear. The service provisioning device 102 can also be positioned on the chest, attached to clothing or as a chest harness to provide close proximity to a normal user's visual field. The service provisioning device 102 may also be positioned around the neck, like a necklace, or lanyard.

The service provisioning device 102 may include, among other components, a camera 112, a positioning device 114, one or more sensors 116, a transceiver 118, one or more applications 120, a user interface 122, one or more processors 124, and a display 126. The camera 112 serves as a visual input component configured to capture real-time images and scenes from the user's surroundings. In some embodiments, additional or few components can be included in the service provisioning device 102.

In some embodiments, the camera 112 is a depth/stereo camera. The depth camera 222 can continuously monitor the user's scene and surroundings and capture the depth images thereof. A “scene” used herein refers to the visual environment or surroundings captured by a camera. A scene may include all the objects, persons, and other relevant elements present in the user's field of view at a given moment. In some embodiments, the scene is dynamic and can change as the user moves or as new objects enter the field of view. The dynamic scene is typically represented by a video, which is essentially a sequence of images captured in real time. The camera 112 on the service provisioning device 102 may continuously captures and transmits a stream of real-time images (i.e., a real-time video stream) to the central server 104.

The depth images can be processed to further generate depth image data. The depth camera may be embodied as a time-of-flight (TOF) camera, a stereovision camera or other types of cameras that generate depth images including information on distance to different points of objects within the user's field of a scene. For example, the stereovision camera can use two lenses to capture images from different locations. The captured images are then processed to generate the depth images. In one embodiment, the depth camera generates grayscale images with each pixel indicating the distance from the depth camera to a point of an object corresponding to the pixel. In some embodiments, the processor 124 may generate real-time scene data such as the image data or depth image data of the captured images and scenes.

The positioning device 114 is configured to position and locate the service provisioning device 102 and generate real-time location and position data of the service provisioning device. For example, the positioning device 114 may be a GPS unit. In some embodiments, the positioning device 114 is further configured to accurately determine the user's location and pinpoint the location of various body parts of the user. The positioning device 114 may make determinations based on the relative positioning of the service provisioning device 102, which is worn by the user, by assessing the orientation and movements of the service provisioning device 102 in relation to the user's body.

The one or more sensors 116 may include a proximity sensor for detecting the presence or absence of objects in close proximity to the service provisioning device 102, environmental sensors for measuring various environmental parameters, such as temperature, humidity, air quality, or ambient light, motion sensors for such as accelerometers and gyroscopes that can detect changes in the orientation and movement of the service provisioning device 102, sound sensors that can capture audio data from the surrounding of the service provisioning device 102, biometric sensors such as heart rate monitors for monitoring the user's physiological state and detecting stress, fatigue, or health-related conditions of the user, obstacle detection sensors specifically used for identifying physical obstacles in the user's path. The sensors 116 may be optional, and the service provisioning device may not include a sensor described above in alternative embodiments.

The transceiver 118 is responsible for facilitating communications (e.g., transmission of wireless radio-frequency signals) between the service provisioning device 102 and the central server 104 via the communication network 105. The transceiver 118 sends various data (e.g., the real-time scene data and location data) from the service provisioning device 102 for analysis and receives instructions and guidance from the central server 104.

The applications 120 may be stored in a memory of the service provisioning device 102 and be executable by the processor 124 to perform various functions. In some embodiments, the applications 120 may include one or more machine learning (ML) modules for processing the real-time scene data generated by the camera 112 and other components of the service provisioning device 102 using ML models. Alternatively, the ML modules may be included in the central server 104 and employed by the central server 104 to process data for the user.

The user interface 122 allows the user to interact with the service provisioning device 102. The user interface 122 may further include one or more input/output devices such as speakers, microphones, touchscreens, among others. The user interface 122 may specifically include an audio user interface (AUI) for the user to interact with the service provisioning device 102. The AUI may include a microphone for audio input to enable voice commands and communication with the service provisioning device 102, an audio output module for delivering personalized audio signals generated by or received in the service provisioning device 102 to the user, and a tactile interface to provide physical feedback and control options generated by or received in the service provisioning device 102 for the user. The tactile interface may include physical buttons, touch-sensitive areas, and/or haptic feedback mechanisms. Users can engage with the service provisioning device 102 by pressing buttons or tapping specific areas, and receive tactile responses to confirm their actions. For example, a user may press a dedicated button to activate a voice command mode, and the service provisioning device 102 responds with a tactile vibration or sound signal. The AUI may further include a text-to-speech module capable of converting text information, such as directions or notifications, into speech, a voice recognition module capable of processing spoken commands from the user, and an alert module capable of generating an audio alert for the user.

In some embodiments, the user interface 122 may include a graphical user interface (GUI) configured to visually present the real-time images of a current scene surrounding the user in the display 126. The GUI may provide an intuitive and graphical representation of the current scene, allowing the user to interact with and comprehend the detected features such as objects, people, text, or other relevant features within the surrounding. The GUI may incorporate features such as object highlighting, object labeling, scene annotation, or dynamic overlays to enhance the user's perception and engagement with the contextual information when the user interacts with the GUI. In other embodiments, the user interface does not include a GUI.

In some implementations, the real-time images presented through the GUI may be seamlessly delivered as a live video stream. The live video stream provides a dynamic and continuous representation of the user's surroundings to reflect the most up-to-date contextual information. The image data of the live video may be processed to provide a real-time depiction of the detected scene and allow for immediate interaction and understanding of the environment as well as prompt identification of a feature such as object, text, and people in the live video for the user in need thereof.

The one or more processors 124 may further include graphics processor unit (GPU) for handling graphics and multimedia processing for any type of application. The display 126 is configured to present the visual or graphic information, in addition to the real-time images of the current scene surrounding the user.

The central server 104 may be a cloud-based computer system and include multiple integral components for provisioning personalized and adaptive guidance and services to the user. The central server 104 may include, among other components, a communication engine 130, an analytical engine 132, a machine learning (ML) engine 142, a point of interest (POI) determination engine 144, an identification engine 145, a reporting/output engine 146, a guidance determination engine 147, and a database 150. Each one of the components of the central server 104 may include a hardware component, a software component, or a combination of both. The various engines, modules, and models may be based on existing public and/or proprietary algorithms. Taking the analytical engine for an example, the analytical engine 132 can be implemented using hardware including a field programmable gate array (FPGA) or an application-specific integrated circuit (ASIC). In some embodiments, the analytical engine 132 can be implemented using a combination of hardware and software executable by processor(s) of the central server. In some embodiments, the analytical engine 132 comprises a set of instructions executable by the processor. In some embodiments, the analytical engine is stored in the memory of the central server and is accessible and executable by the processor.

The communication engine 130 is responsible for managing data exchange with the service provisioning device 102. The analytical engine 132 may further include one or more recognition modules such as scene recognition module 134, object recognition module 136, text/character recognition module 138, and facial recognition module 140, other specifically designed scenario recognition modules, and a positioning module 141, to process the real-time user data and image data transmitted from the service provisioning device 102. The analytics engine 132 may extract information from these data sources, recognize scenes, objects, texts, and individuals within the user's surrounding, and calculate/estimate/determine the position, size, depth, and distance of the object or individual relative to the user or a body part of the user. In some implementations, the analytical engine 132 may employ various pre-developed analytical models stored in the database 150 to perform the functions. In some embodiments, the analytical models may be ML models.

The ML engine 142 may be integrated into the central server 104 and operate in a collaborative manner with the analytic engine 132 or other components to enhance the capability to adapt to individual user profiles and user-specific features. The ML engine 142 may be configured to train various ML models for the analytical engine 132 (i.e., scene recognition module 134, object recognition module 136, text/character recognition module 138, facial recognition module 140, positioning module 141, etc.) to use in performing the analytical functions.

For example, the ML engine 142 can be configured to develop and train an object recognition model by performing one or more of the following: collecting a dataset of images representing the various objects that the model needs to recognize in the user's surroundings, preprocessing the dataset, for example, by standardizing the size of images, normalizing pixel values, augmenting the dataset to enhance variability, annotating the dataset by labeling each image with the corresponding object or class that the object recognition model should identify, and designating the labeled dataset as the ground truth for training, selecting an appropriate architecture for the object recognition model, such as convolutional neural networks (CNNs) or specially-designed architectures, training the object recognition model using the labeled dataset to learn to identify patterns and features associated with different objects in the images, validating the performance of the object recognition model on a separate dataset not used during training, evaluating the trained model on a testing dataset, and integrating the trained model into the central server 104. Similarly, ML engine 142 can be used to develop and train scene recognition model, text/character recognition model, facial recognition model, and poisoning model in a similar manner. The trained model can be deployed and further optimized during operation, for example, through implementation of mechanism for continuous improvement, periodic retraining with new data to adapt the model to evolving scenarios over time.

The POI determination engine 144 is configured to identify/determine a current POI of the user, identify/determine an association level of the POI with a recognized feature (e.g., the recognized scene, objects, texts, or individuals) with the POI. In some embodiments, the central server 104 may receive a user command sent from the service provisioning device 102. The user command may indicate a POI of the user, for example, a particular feature (e.g., a scene, an object, texts, or an individual) the user is seeking. The POI determination engine 144 may process the user command and identify the indicated POI. The POI determination engine 144 may further identify/determine whether each one of the recognized objects is associated with the POI, or alternatively, an association/correlation/relevance level between each one of the recognized objects with the POI.

The POI may be specifically indicated by the user command or predicted by the central server 104 if no user command is received. For example, the POI may indicate target scene (e.g., a retail store, a library, a park, a bus stop, an airport, a cabin of a transportation tool, a museum, a campus, a town center, a healthcare facility, a residential area, an apartment, an indoor space, etc.), a target object (e.g., a merchandise, a good, a product, a seat, a landmark, a building, a shop, a room, etc.), target information (e.g., a price tag, a promotional display, a bus number, a gate number, etc.), a target place (e.g., an aisle or section in a retail store, a seat in a bus, a bench in a park, a boarding area, etc.), a target person of a group of persons.

In one example implementation, a user wearing the service provisioning device 102 is in a retail store, and the user sends an audio input to the service provisioning device 102 indicating an interest in a target merchandise. The service provisioning device 102 receives the audio input, converts it into a user command indicating the user's interest, and sends the user command to the central server 104, along with real-time image data of the user's surrounding obtained by the camera of the service provisioning device 102. The central server 104 may employ the analytical engine 132 to analyze the real-time image data and recognize one or more objects of the user's surrounding and further determine an association level between each of the recognized objects and the target merchandise, The analytical engine 132 may further rank the association level based on relevance and prioritize the objects closely associated with the user's POI. Using this information, the central server 104 may generate an output instruction and/or a guidance/service instruction and send instructions back to the service provisioning device 102, which outputs personalized audio signals, providing the information of the identified objects and/or guiding the user to the target merchandise in real-time.

In another implementation, a user wearing the service provisioning device 102 is at a bus stop waiting for a target bus for boarding and transportation. The user utilizes the service provisioning device 102 to convey through an audio input an intention to board a user-specified or target bus. The service provisioning device 102 converts the audio input into a structured user command and transmits it along with real-time images of the scene of bus stop to the central server 104. The analytical engine 132 of the central server 104 analyzes the images, recognizes the various buses entering the scene, extracts various textual information such as bus number and other relevant features of each entering bus, and determines whether the bus number is the same as the target bus number. The central server 104 may generate an output instruction and/or a guidance/service instruction and send instructions back to the service provisioning device 102, which outputs personalized audio signals and informs the user of the bus number of the recognized bus in the scene and whether the bus number of the recognized bus is the same as the user-specified or target bus number.

In some embodiments, the POI determination engine 144 may identify a POI based on at least one of the recognized scenes of the user, the current location of the user, and/or a user characteristic or user preference from the user profile, absent a user command or user-specified target. In one example implementation, the user starts navigating a crowded street while wearing the service provisioning device 102. The service provisioning device 102 captures real-time scene data using the camera thereof and transmits the real-time scene data to the central server 104. The central server 104 employs one or more models such as object recognition models, text/character recognition model, facial recognition model, scene recognition model, positioning model, and depth/distance model to analyze the captured scene, identify/determine moving obstacles, such as pedestrians, bicycles, and vehicles, based on the dynamic patterns, predict the potential impact or level of obstruction on the user's path based on parameters such as speed, direction, and proximity. The POI determination engine 144 may identify/determine the need for obstacle avoidance, based on the potential impact or the predicted level of obstruction. Based on the identified POI, the central server 104 may generate a guidance instruction to assist the user in avoiding obstacles. The guidance may include suggestions for alternative routes, alerts about upcoming obstacles, or information about safe zones. The central server may send the guidance instruction back to the service provisioning device 102, which may convert the guidance instruction into audio signals suitable for outputting through the user interface.

In some implementations, the POI determination engine 144 may identify a POI based on real-time communication or interaction between the user and the service provisioning device 102. For example, the service provisioning device 102 may send an inquiry (e.g., an audio inquiry) to the user requesting a user-specified interest, target, or intention from the user. The user may respond to the inquiry with a user input (e.g., an audio input) containing user information that indicates a user-specified interest, target, or intention. The service provisioning device 102 may process the input to extract user information about the user-specified interest, target, or intention and send the information to the central server 104. The POI determination engine 144 may identify/determine one or more POIs, based on the user information. In some embodiments, the service provisioning device 102 may transmit the user input to the central server 104. The analytical engine 132 may employ an information extraction model to extract user information from the user input. The information extraction model may be developed and trained by the ML engine 142, using historical dataset specific to the user. In some implementations, when the analytical engine 132 recognizes features (e.g., objects, texts, semantics, faces, etc.) from the real-time image or scene data, the service provisioning device 102 may send an inquiry to the user requesting for additional information about the POI. The user may respond to the inquiry with a user input or a series of user inputs containing additional user information (e.g., more specific information) about the POI. The service provisioning device 102 receives the response and sends it to the central server 104. The POI determination engine 144 may determine the association level between each of the recognized features and the POI, based on the additional information.

The identification engine 145 is configured to identify the recognized features (e.g., recognized objects, texts, or persons) of the scene associated with the POI, based on the association level between the recognized feature and the POI. In some embodiments, the identification engine 145 further includes, among others, an object identification module 151, facial/person identification module 152, and a text identification module 153.

The object identification module 151 is generally configured to identify and select the recognized object(s) that are relevant to the POI for reporting. In some embodiments, the object identification module 151 may be configured to rank the association levels of each one of the recognized objects in the scene and select the objects that have the association levels higher than a predetermined threshold for reporting. Similarly, the person identification module 152 is configured to identify and select the recognized person(s) that are more relevant to the POI for reporting. In some embodiments, the person identification module 152 may be configured to rank the association levels of each one of the recognized persons in the scene and select the person(s) that have the association levels higher than a predetermined threshold for reporting.

The text identification module 153 is generally configured to identify text information recognized in the scene and associated with the identified objects or persons for reporting. For example, the text identification module 153 may employ text/character recognition models to identify and extract textual information present in the captured scene, determine the association of the identified text with specific objects or persons within the scene, based on the spatial location of the text relative to recognized objects or persons. The text identification module 153 may establish criteria for selecting relevant text information for reporting. Criteria may include the proximity of the text to the identified Point-of-Interest (POI), user preferences, or the type of recognized object or person. In some embodiments, the text identification module 153 is further configured to perform semantic analysis on the identified text to extract one or more semantic features related to the text.

In some embodiments, the identification engine 145 is configured to identify and select the recognized object(s) and/or persons in a dynamic scene containing moving objects or persons. The identification engine 145 can utilize scene recognition models to dynamically identify and adapt to changes in the scene. The modules within the identification engine 145 can identify and select objects and/or persons that are in motion within the captured scene. The dynamic identification and selection process may involve continuous analysis of the dynamic scene to track and recognize moving entities. The identification engine 145 continuously adapts the selection and identification criteria to account for changes in the position and characteristics of objects and/or persons. The identification engine 145 may further apply a prioritization logic to focus on relevant objects or persons based on the POI and user context to the user to receive information about moving features in the dynamic scene that are most pertinent to their current interests or needs.

The reporting/output engine 146 is generally configured to generate outputs containing information related to the identified objects and/or persons, along with associated text. In some embodiments, the output engine 146 can generate a report, including reporting content, audio signals for articulating the reporting content, and instructions for delivering the information. The central server 104 can transmit the report in real-time to the service provisioning device 102. The reporting content includes details about the recognized objects and/or persons and their associated text. Audio signals are produced utilizing a predetermined language model and adhering to the user's preferred language. The instruction may include a reading order for conveying information about each identified object in a manner appropriate for or preferred by the user.

The terms “contextual sequence,” “reading order,” “reading sequence,” or the like used herein refer to the sequence in which identified/selected objects and the identified features associated with the objects are presented to the user through audio signals. The reading order is used to convey audio information to the visually impaired user in a structured and personalized manner. The reading order may include an object priority reading order. For example, when multiple objects are identified in the scene, a reading order may be established to convey the information about the identified objects in a sequence based on their priority or relevance to the determined POI. For another example, when multiple features associated with an object are identified in the scene, a reading order may be established to convey the information about the multiple features in a sequence based on their priority or relevance to the determined POI. The reading order may also include a sequential text reading order. For example, in cases where various texts are associated with an identified object, a reading order may be employed to sequentially read out these texts. The sequential text reading order may be determined based on their association levels with the identified object to allow the user to grasp detailed information in a systematic and organized manner.

In an example scenario, a reading order may be generated to convey audio information about objects at a bus stop for a visually impaired user at the bus stop. In response to the determined POI of the user in boarding a specific bus at the bus stop, the output engine 146 may generate a structured reading order to convey relevant information regarding an approaching bus. The reading order may instruct the service provisioning device 102 to first read out the bus arrival information pertaining to the approaching bus. This includes details such as the bus number, estimated arrival time, and destination to provide the user with essential information about the bus. The reading order may instruct the service provisioning device 102 to secondly read out the characteristics of the approaching bus to provide details on features like the presence of air conditioning, the number of stories (if applicable), and the current occupancy status of the approaching bus to allow the user to receive information about the attributes of the bus. The reading order may instruct the service provisioning device 102 to thirdly read out contextual information, such as the arrangement of the waiting passengers in the line for boarding the bus, in order to further enhance the user's perception of the surroundings.

In another example scenario, a reading order may be generated to convey audio information about merchandise in a retail store for a visually impaired user at the retail store. The service provisioning device equipped by the visually impaired user equipped identifies an interest in a specific merchandise expressed by the user as the POI and identify target merchandises in the scene that matches with the target merchandise and the POI. A reading order may be generated to instruct the service provisioning device 102 to firstly read out the name and identification of the identified merchandise, secondly read out the precise location of the identified merchandise (e.g., shelve number, position on the shelve), and thirdly read out the characteristics and features of the merchandise. For example, the characteristics and features of the merchandise may include package size, brand attribute, pricing detail, ongoing promotion/discount information associated with the merchandise, which can also be read out in a predetermined sequence.

In some embodiments, the central server 104 may send a query to the user or instruct the service provisioning device 102 to send a query to the user for more information about a POI and/or a target object the user is seeking during the determination of POI and/or the identification of objects/persons in the scene. The service provisioning device 102 may receive a user response to the query and timely forward the user response to the central server 104. The central server 104 may determine the POI and/or identify objects/persons based on the user response.

The guidance determination engine 147 is configured to determine a user-specific and personalized guidance or service, based on the user's location, identified scene, or determined POI associated with the user, and/or the identified object/person matching the POI. In some embodiments, the guidance determination engine 147 may generate a guiding instruction and send the guiding instruction to the service provisioning device 102. The service provisioning device 102 may convert the guiding instruction into audio signals and output the audio signals for the user to perceive the guidance. For example, in the bus stop scenario, the guiding instruction might include step-by-step guidance on approaching the bus, boarding protocol, and available seating options. In the retail store scenario, the guiding instruction may entail instructing the user on the most efficient route to the desired merchandise, highlighting ongoing promotions, aiding in navigating the store, and so on.

The personalized services and guidance determined by the central server 104 include but are not limited to object recognition, location recognition, facial recognition, text/character recognition, information provisioning (e.g., reading out information about the object, person, and scene features to the user), indoor guidance, outdoor guidance, navigation guidance, orientation guidance, entrance guidance, shopping support, transportation boarding guidance, reading assistance, facility access guidance, wayfinding guidance, object location guidance, POI guidance, and so on.

It should be noted that the guidance determination engine 147 may also be responsible for continuously monitoring, analyzing, and adapting the guidance and services provided to users based on the evolving needs and the real-time data received from the service provisioning device 102. The guidance determination engine 147 can employ various ML models and algorithms to dynamically adjust the guidance and services according to the user's context, location, preferences, and detected changes in their surroundings.

The database 150 is responsible for storing various data and information related to service and guidance provisioning. The database 150 may include, among other data profiles, a user profile 160 specific to a user, one or more ML models 162, and one or more scenario profiles 164. The user profile 160 is user-specific and may contain data and information related to the individual user's preferences, habits, and specific needs. The user profile 160 may further include one or more user features specific to a location, a scenario, based on historical user behavior. The features specific to both the user and the location or scenario can aid in personalizing the guidance and services provided by the central server 104.

The ML models 162 may include various models, including scene recognition model, object recognition model, text/character recognition model, facial recognition model, position models, depth/distance model, and more. Scene recognition model may be developed and trained to analyze and map the environment. Object recognition model may be developed and trained to identify objects and obstacles. Text/character recognition model may be developed and trained to read and interpret text. Facial recognition model may be developed and trained to detect and recognize individuals in the scene or surroundings of the user.

Position model may be developed and trained to calculate, estimate, or determine the precise and accurate position of an object or person within the user's surrounding relative to the user. In some embodiments, the position model may also be used to determine the position of one object or person relative to another object or person. Depth model may be developed and trained to gauge the spatial size, depth, or distance of object or person within the user's surroundings. The depth/distance model may utilize real-time image data from sensors such as depth cameras or stereoscopic imaging sensors installed in the service provisioning device 102 to generate a three-dimensional understanding of the environment and calculate/determine the distances between the user and nearby objects. In some embodiments, the depth/distance model can be used to estimate the distance between the object or person in the scene with a body part of the user. For example, the depth/distance model can be configured to determine the spatial separation between objects or individuals within the scene and specific body parts of the user. The depth/distance model may calculate the physical gap or proximity between, for instance, the recognized objects or persons and a designated body part of the user.

The scenario profiles 164 are collections of pre-defined or pre-established situations or scenarios that the central server 104 can recognize and respond to. The pre-defined scenarios are user-specific and can encompass various contexts, such as crossing a street, navigating a shopping mall, or boarding public transportation. Each scenario profile may further include reference scenario features specific to that scenario and specific to the user. The central server 104 may use these scenario profiles to determine the appropriate guidance for the user based on the recognized scenario.

The ML model 162 may be personalized and customized, by the ML engine 142 using user-specific, location-specific, and scenario-specific data and user-specific training and development protocols. In one example, a process for generating an ML model for object recognition includes: receiving a dataset of labeled images including objects of interest; preprocessing the dataset to standardize image sizes, resolutions, and formats and to remove any noise or irrelevant information, the preprocessing conducted by a data preparation module; dividing the preprocessed dataset into training and validation subsets, the division carried out by a data partitioning module; training the ML model using the training subset, the training conducted by a ML training module employing a training protocol such as convolutional neural networks (CNNs) for feature extraction and classification; validating the trained model using the validation subset, the validation executed by a model evaluation module, which assesses performance metrics such as accuracy, precision, recall, and F1-score; adjusting hyperparameters of the model based on the validation results, the adjustments managed by a hyperparameter optimization module; continuously monitoring performance of the model against a predefined threshold, whereby if the performance falls below the threshold, retraining the model with an updated dataset, the monitoring and retraining functions executed by a model maintenance module; and storing the trained and validated machine learning model, the hyperparameters, and any associated metadata in a model repository, the storage conducted by a model storage module. Other processes for generating various other ML models for object/person/text/character recognition, POI determination, user intention prediction, object identification and selection, as well as guidance determination, are also possible and within the scope of the present disclosure.

The communications network 105 may include a high-speed and low-latency wireless network, including 4G, 5G, and potentially future technologies such as 6G or 7G. The communications network could enable rapid and efficient transmission of real-time data from the service provisioning device 102 to the central server 104 and the subsequent delivery of personalized guidance instructions from the central server 104 to the service provisioning device 102. In some embodiments, the communications network 105 employs a low-latency 5G Ultra-Reliable Low-Latency Communication (URLLC) that provides a latency level at 10 milliseconds or 1 millisecond. The low-latency characteristics of the communications network 105 may be advantageous for real-time applications to facilitate timely and accurate assistance for visually impaired and elderly users in various scenarios.

The database 106 may provide data sources from public or third parties that can be readily accessible by the central server 104 and/or the service provisioning device 102. Non-limiting examples of the data provided by the database 106 may include detailed maps and geographical information such as streets, landmarks, and points of interest; real-time public transportation data, such as bus schedules, routes, and train timetables; location-based services providing information on nearby businesses, restaurants, and services; address databases for accurate geolocation; weather information for current and forecasted conditions; traffic data, including congestion reports and road closures; emergency services information to ensure user safety; information about public events; and data related to accessibility, including the availability of ramps, elevators, and other facilities to support users with special needs.

FIG. 1B is a block diagram illustrating another example communications system 100B (hereinafter “system 100B”) for monitoring surroundings of a user and provisioning personalized services and guidance to the user, according to various embodiments. System 100B is a variation of system 100A and may include, among other components, a service provisioning device 102′, a central server 104, a communications network 105, and a database 106. Various components of the central server 104 of system 100A can be included in the service provisioning device 102′ of system 100B. For example, the service provisioning device 102′ includes a camera 112, a positioning device 114, one or more sensors 116, a transceiver 118, one or more applications 120, a user interface 122, one or more processors 124, a display 126, an analytics engine 132, a machine learning (ML) engine 142, a point of interest (POI) determination engine 144, an identification engine 145, a reporting/output engine 146, a guidance determination engine 147, and a database 150.

In other words, the service provisioning device 102′ of system 100B is configured to perform various functions of the central server 104 of system 100A, such as object/person/text/character recognition, feature identification, POI determination, object/person identification and prioritization, output, and guidance determination. The central server 104 may be operable to develop/train various user-specific models (e.g., ML models, object recognition models, etc.), provide the models for the user, and update the models.

Systems 100A and 100B, service provisioning device 102 or 102′, and central server 104 as described above can be used in various applications for provisioning personalized services and guidance to users in need thereof. The following examples are for illustrative purposes only and should not be considered limiting. Other use case applications employing system 100A or 100B and the service provisioning device 102 or 102′ are also possible and thus are within the scope of the present disclosure.

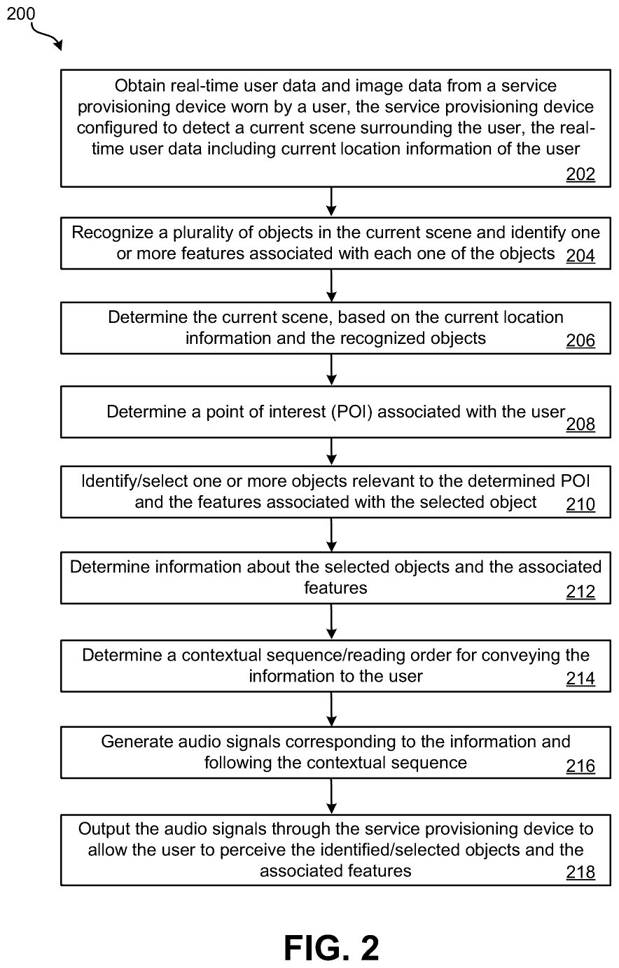

FIG. 2 is a flow diagram illustrating an example method 200 for provisioning service/guidance to a user in need thereof, according to various embodiments. Method 200 may be performed by the system 100A or 100B or the service provisioning device 102 or 102′. Depending on the implementation, method 200 may include additional, fewer, or alternative steps/operations performed in various orders or in parallel. Method 200 or any steps/operations thereof may be combined with other methods or operations thereof described herein in a suitable manner.

At 202, real-time user data and image data of a current scene surrounding a user are obtained by a service provisioning device worn by the user. The user may be visually impaired. The current scene may be detected by a camera or a sensor of the service provisioning device. The real-time user data may include current location information (e.g., GPS signals represented by a set of Cartesian coordinates [X, Y, Z] corresponding to latitude, longitude, and altitude of a current position of the user). The image data may be obtained by analyzing/processing images or live videos of the current scene.

At 204, the image data is analyzed using one or more of scene recognition, object recognition, facial recognition, and text/character recognition techniques to recognize a plurality of objects and/or persons in the scene. One or more features associated with each one of the objects and persons are also identified.

At 206, the current scene is determined based on the current location information and the recognized objects. For example, the current scene may be determined to be a bus stop based on the geographical location of the user and the recognized objects/texts in the scene (e.g., a street name, a reference landmark, etc.). For another example, the current scene may be determined as a retail store, based on the geographical location of the user and the recognized objects/texts in the scene (e.g., name of the retail store, etc.). In some embodiments, a database of pre-established reference scenes is used as reference for determining the current scene of the user. For example, the current scene and/or the recognized objects/persons/texts within the current scene are compared with the reference scenes and/or the reference objects/persons/texts included within the reference scenes, and the reference scene that matches the current scene is identified based on the comparison.

At 208, a point of interest (POI) associated with the user is identified. In some embodiments, the POI is determined at least partially based on the real-time user data. In some embodiments, the POI is determined based at least partially on one or more user characteristics from a pre-established user profile specific to the user. The one or more user characteristics may be identified based on the historical user behavior at a location same as or similar to the current location of the user, or at a scene same as or similar to the current scene of the user.

In some embodiments, the POI is determined based on a user command or instruction received by the service provisioning device. For example, a user may send a user request (user command or user instruction) to the service provisioning device (through an audio user interface) for information regarding an object or person of interest, and the POI is determined based on the user request. In some embodiments, the POI is determined based on real-time interaction between the user and the service provisioning device. For example, the service provisioning device may send a query (e.g., an audio query) for a POI to the user, receive a user response containing information about the POI and/or indicating a user intent, and determine the POI based on the user information.

In some embodiments, a user intent is determined based on the POI and/or the user request. The user intent may be detailed information about a specific object or location in their surroundings, guidance or assistance in navigating to a particular destination or object, assistance in performing a specific task, such as finding a specific item in a store, an interest in exploring and understanding the details of the current scene or environment. In some embodiments, the user intent may be automatically and intelligently identified absent a user request or user instruction.

At 210, one or more identified objects associated with or relevant to the identified POI are selected/identified from the plurality of objects. One or more features associated with the selected objects are also selected.

At 212, information about the selected objects and the associated features are determined, by the service provisioning device or the central server.

At 214, a contextual sequence for providing the information to the user is determined, by the service provisioning device or the central server. The contextual sequence may be a reading order for reading the information to the user through generation and output of audio signals through the service provisioning device. The reading order may define the sequence of multiple objects to be conveyed to the user as well as the sequence of the features associated with each object to be conveyed to the user.

At 216, audio signals corresponding to the information to be provided to the user following the contextual sequence are generated, by the service provisioning device or the central server. At 218, the audio signals are output through an audio user interface of the service provisioning device to allow the user to perceive and understand the selected object.

In one specific use case, consider a scenario where the user is currently at a local bus station, and the POI is identified as the user's interest in boarding a bus for a specific destination. Objects in the user's surroundings at the bus station, such as buses, bus stops, ticket machines, or other relevant elements may be identified. Features associated with the detected objects could include details about the available buses (e.g., bus numbers, departure times), information about the bus stop (e.g., location, schedule), and any other pertinent details. The plurality of objects detected and recognized in the scene of the user may include the bus relevant to the POI, as well as other pedestrians, moving motor vehicles irrelevant to the POI. When the bus relevant to the POI and user intent is detected in the scene and identified by the service provisioning device as relevant to the POI, the information about the features of the identified bus is determined. A reading order for the information is generated, and the information about the bus is provided to the user through output of audio signals.

In another specific use case, consider a scenario where the user is currently at a local shopping store, and the POI is identified as the user's interest in a specific merchandise product. Objects detected in the scene may include various shelves, merchandise products on the shelves, and other store-related elements. A POI associated with the user indicating the user's interest in a specific merchandise product within the store is identified. Alternatively, a user intent may be predicted based on historical behavior in the same or similar store, scene analysis, or explicit user commands related to the store visit. Merchandise products in the user's surroundings relevant to the identified POI are selected, and features associated with the selected merchandise product, including type, price, expiration date, precise position on the shelf, and other relevant details are identified. Information about the identified merchandise product may be determined for provisioning, based on user preferences and relevance. For example, a plurality of merchandise products relevant to the POI may be prioritized based on a predicted user preference based on historical user behavior or based on a pre-established user profile. A contextual sequence or reading order may be established for conveying the information to the user within the store environment. Audio signals are generated and output by the service provisioning device in accordance with the established reading order to allow the user to perceive relevant details about the selected merchandise product.

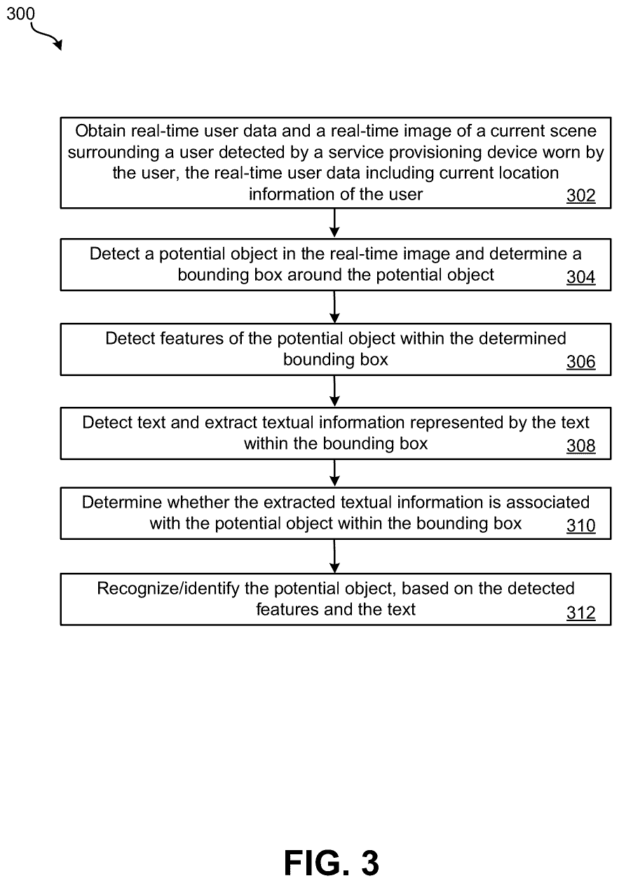

FIG. 3 is a flow diagram illustrating an example method 300 for recognizing an object from an image of a scene. Method 300 may be performed by system 100A or 100B or service provisioning device 102 or 102′. Depending on the implementation, method 300 may include additional, fewer, or alternative steps/operations performed in various orders or in parallel. Method 300 or any steps/operations thereof may be combined with other methods or operations thereof described herein in a suitable manner.

At 302, real-time user data and an image of a current scene surrounding a user are obtained by a service provisioning device worn by the user. At 304, the image is processed by the service provisioning device or a central server connected to the service provisioning device to detect a potential object in the image. A bounding box encompassing the potential object is determined, for example, using an object recognition model. In some embodiments, a dynamic bounding box algorithm may be employed to adapt in real-time to the shape, movement, and size of the potential object.

At 306, one or more features of the potential object within the determined bounding box are detected, by the service provisioning device or the central server. Example features include but are not limited to color or color combination, surface texture, geometric shape or outline, dimensions (height, width, and depth), orientation within the scene, inherent motion or changes in position, three-dimensional depth, patterns or markings, contextual relationships with nearby objects, as well as temporal changes in features over time.

At 308, text is detected, by the service provisioning device or the central server, within the bounding box. A text/character recognition model may be employed for detecting the text and extracting textural information from the detected text. In some embodiments, the text/character recognition model may leverage deep learning techniques, such as convolutional neural networks (CNNs) and recurrent neural networks (RNNs) to recognize the text within the bounding box. The text/character recognition model may further incorporate multiple layers for feature extraction, sequence modeling, semantic analysis, and context analysis based on the recognized text/character. The text/character recognition model may employ natural language processing (NLP) mechanisms for refining and structuring the extracted textual features and determining their relevance for subsequent stages of object recognition and interpretation.

At 310, a determination is made, by the service provisioning device or the central server, on whether the extracted textual features is associated with the potential object within the bounding box. In some embodiments, a contextual analysis is performed to determine a spatial and/or semantic relationship between the detected text and the extracted features of the potential object. For example, spatial coordinates within the bounding box can be used to establish a geometric relationship to determine whether the detected text is aligned with and/or encapsulates relevant portions of the potential object. A semantic relationship may be established to evaluate the coherence between the extracted textual information and the extracted features of the potential object.

At 312, the potential object is recognized and identified, by the service provisioning device or the central server, based on the detected features and the text associated with the potential object.

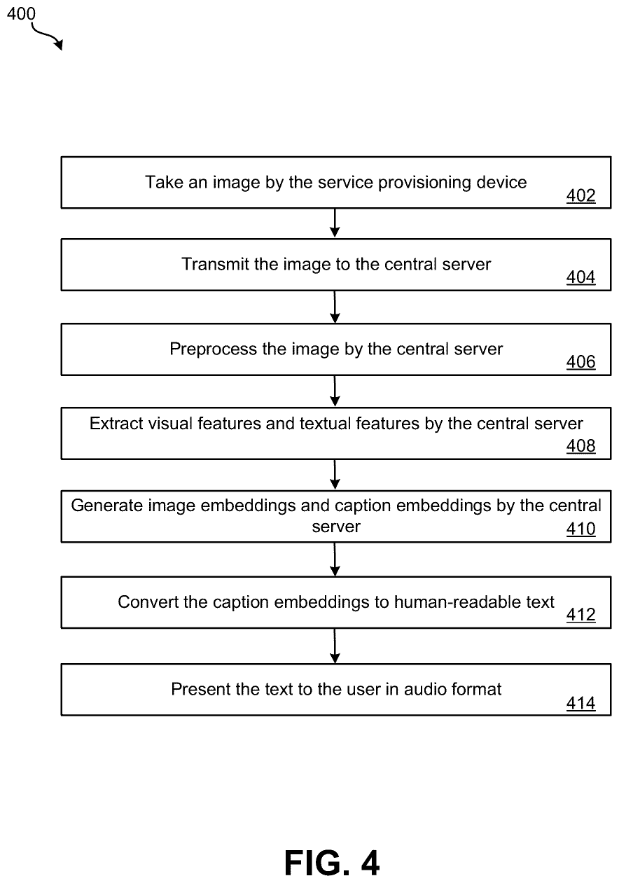

FIG. 4 is a flow diagram illustrating an example process 400 of scene recognition. Process 400 may be performed by system 100A or 100B or service provisioning device 102 or 102′. Process 400 or any steps/operations thereof may be combined with other methods/processes or operations thereof described herein in a suitable manner.

At 402, an image of a scene surrounding a user is generated by a service provisioning device worn by the user. At 404, the image is transmitted to a central server via a network. At 406, the image is preprocessed by the central server. In some embodiments, the pixel values of the image are normalized. The preprocessing may further include resizing the image to a specific resolution, center-cropping, or padding the image to match predetermined requirements.

At 408, a visual encoder (e.g., in the scene recognition module) of the central server is activated to extract visual features from the image, capture the visual content, and generate an image embedding. At 410, a text encoder is activated to detect the text, extract semantic of the text, and generate captions based on the image embedding. The captions can be encoded using the text encoder to produce caption embedding. At 412, the caption embeddings are converted to human-readable text using a transformer-based model. The decoding process involves sampling words or sub-words based on the caption embeddings. At 414, the captions are presented to the users in audio format (e.g., converted to audio signals corresponding to the caption embeddings in a preferred language of the user). In some embodiments, audio signals representing the human-readable text are generated by the central server and provided to the service provisioning device, which outputs the audio signals to the user via an audio user interface (AUI).

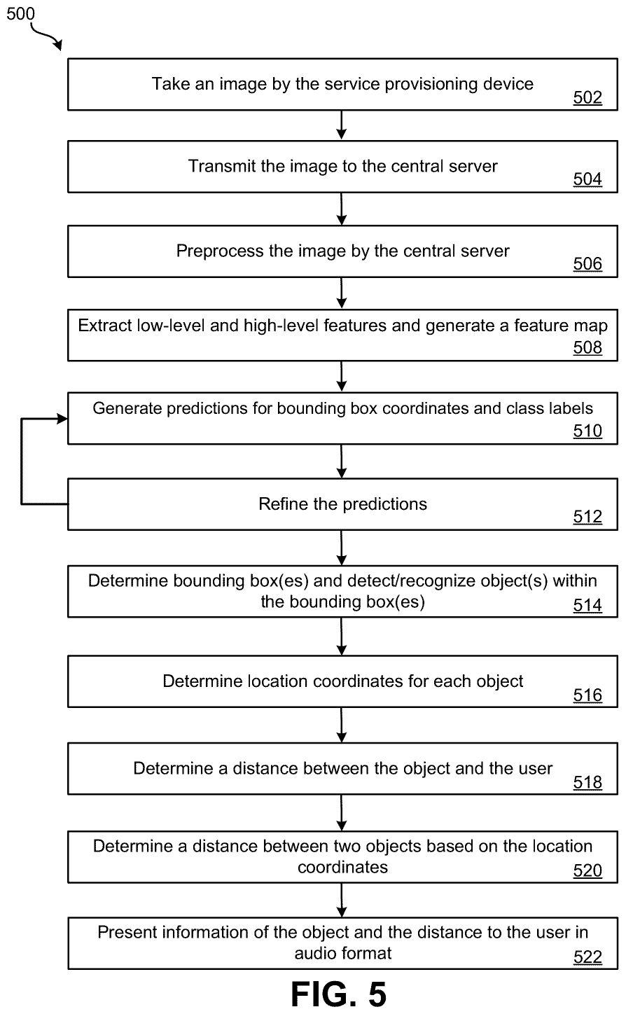

FIG. 5 is a flow diagram illustrating an example process 500 of depth/distance determination. Process 500 may be performed by system 100A or 100B or service provisioning device 102 or 102′. Process 500 or any steps/operations thereof may be combined with other methods/processes or operations thereof described herein in a suitable manner.

At 502, an image of a scene surrounding a user is generated by a service provisioning device worn by the user. At 504, the image is transmitted to a central server via a network. At 406, the image is preprocessed by the central server. In some embodiments, the pixel values of the image are normalized. The preprocessing may further include resizing the image to a specific resolution, center-cropping, or padding the image to match predetermined requirements.

At 508, visual features are extracted from the image by the central server. The visual features may include both high-level features and low-level features. Low-level features may include edges, textures, and colors, while high-level features may include object shapes and patterns. For example, in a street image, low-level features might include the edges of cars and buildings, while high-level features might identify the shapes of pedestrians and vehicles.

At 510, the central server may operate to predict where objects are located within the image (e.g., bounding boxes), assign class labels to the features within the bounding boxes, and assign an initial confidence score to these predictions. For example, coordinates of a bounding box in a rectangular area around visual features of a car in the image may be predicted, the bounding box is labeled as “car,” and a confidence score of 85% is assigned to the features within the bounding box. In some embodiments, if multiple bounding boxes overlap, an intersection over union (IoU) score may be generated for the overlapping bounding boxes. The IoU score can be used to determine which bounding boxes represent the same object and should be merged or discarded if these bounding boxes do not meet a certain threshold.

At 512, the prediction is refined. In some embodiments, the prediction can be refined by repeating the operation at 510 to obtain an updated confidence score for each bounding box until the updated confidence is of or above a predetermined threshold. In some embodiments, post-processing techniques may be employed to refine the prediction, including but not limited to, filtering out the detections below a certain confidence threshold to remove low-confidence predictions. Non-maximum suppression (NMS) can then be applied to select the most confident bounding box among a group of overlapping bounding boxes based on their intersection over union (IoU) scores and reduce redundant bounding boxes for the same object and keep the one with the highest confidence score.

At 514, After refinement, the bounding boxes are determined and the object(s) within each bounding box are detected and recognized. In some embodiments, the textual features related to the object (e.g., a bus number of a bus as a detected object) within the bounding box are also identified. The textual features are determined to be related to the object (e.g., representing an attribute of the object).

At 516, location data (e.g., location coordinates in terms of pixels or real-world measurements) for each object are calculated/determined. In some embodiments, depth information (obtained from a stereo/depth camera of the service provisioning device) to convert pixel-based coordinates to real-world measurements. The calculated real-world coordinates can be used in conjunction with predetermined reference location data (e.g., GPS coordinates or mapping data) to determine the exact location of the object. In some embodiments, edge detection algorithms may be used to identify the edges of the object within the bounding box, contour detection algorithms may be used to trace the detected edges and extract the contours of the object. Each point on the contour may be mapped to its pixel coordinates in the image. Optionally, approximation algorithms may be used to simplify the contour into a series of straight-line segments. The depth of each contour point may be calculated to define the outline of the object.

At 518, a distance between the object and the user is determined, based on the location data associated with the object and the location data associated with the user. The location data associated with the user may be obtained from geographic location data obtained from the positioning device such as GPS of the service provisional device. The location data associated with the object is obtained from the process block 516.

At 520, a distance between two objects is determined, based on the location data associated with each one of the two objects. The determined distances are converted into distance information associated with the detected object.

At 522, the detected object information and calculated distance information associated with each object is converted into audio format and presented to the user, according to the embodiments of the present disclosure.

In some embodiments, the identified objects may be prioritized based on their relevance to the user (e.g., a determined POI), according to the present disclosure. The detected object information and calculated distance information associated with an object may also be prioritized based on their relevance to the user. Objects determined to have a relevance to the POI higher than a predetermined threshold are selected, and the information associated with the selected objects is converted to audio format and presented to the user.

In one example use case scenario, process 500 may be used for navigation and obstacle Avoidance. Live video stream recording the scene around the user may be generated by the service provisioning device carried by the user. The live video stream is simultaneously transmitted to the central server. The central server may process each video frame of the video stream, identify objects in each video frame, extract information associated with each object, and determine a distance between the identified object and the user. The central server may track the distance between the identified object and the user and generate a warning message when the distance is within a predetermined threshold (e.g., three meters along the user's walking path). The warning message may be converted to the audio format and timely presented to the user to allow the user to avoid the object. A guidance message may also be generated and presented in an audio format to the user. The guidance message may include a recommendation for the user to take an action (e.g., changing the walking path) to avoid the object.

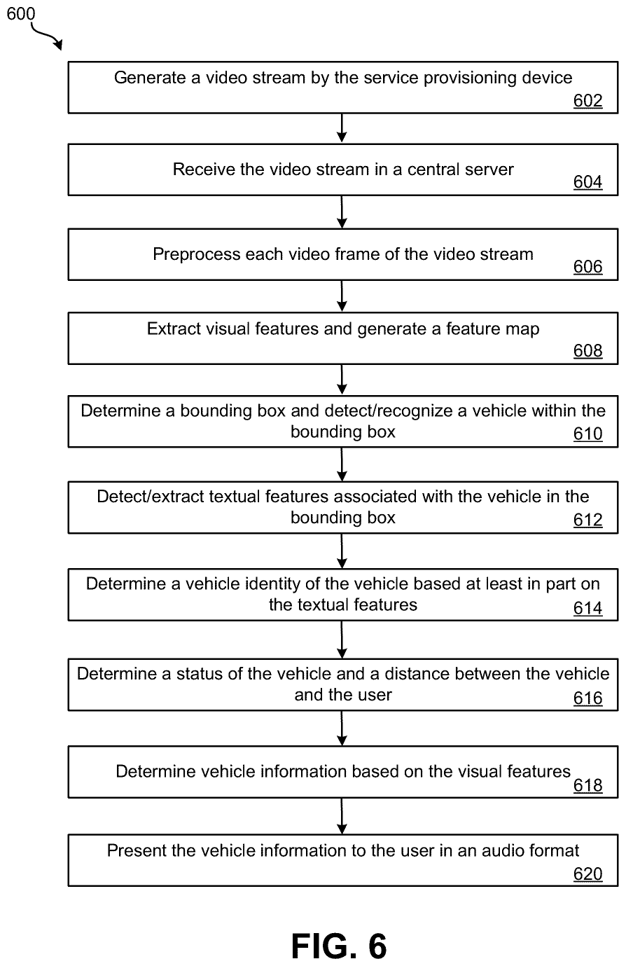

FIG. 6 is a flow diagram illustrating an example process 600 for vehicle detection and transportation assistance. Process 600 illustrates an example implementation of process 500 in a specific use case scenario. Process 600 may be performed by system 100A or 100B or service provisioning device 102 or 102′. Process 600 or any steps/operations thereof may be combined with other methods/processes or operations thereof described herein in a suitable manner.

At 602, a live video stream is generated by a service provisioning device carried by a user near a transportation service location (e.g., a bus top). The live video stream captures an environment around the user. At 604, the live video stream is simultaneously transmitted to a central server via a network. The video stream is received in the central server. At 606, each video frame of the video stream is preprocessed by the central server. At 608, visual features of each video frame are extracted by the central server, and a feature map is generated. An AI/ML model may be used to generate the feature map. For example, the image is passed through multiple convolutional layers of a convolutional neural network (CNN). Each convolutional layer of the CNN includes several filters that slide over the image to detect specific visual features. After convolution, activation functions are applied to introduce non-linearity and enhance the representation of each visual feature. Pooling layers are used to refine the feature map and reduce dimensionality. Each filter in a convolutional layer can produce a separate feature map, and a stack of feature maps that represent different aspects of the image can be generated. In some embodiments, the feature maps are visualized as two-dimensional (2D) matrices where each element of the 2D matrices corresponds to the presence or strength of a specific visual feature in the image.

At 610, a bounding box of a video frame is determined by the central server, and a vehicle within the bounding box is recognized/detected by the central server. In some embodiments, a prediction of bounding box coordinates is made by a trained model of the central server, and the prediction is refined until a confidence score is of or above a predetermined threshold. The output of the bounding box and the recognized vehicle therein can be extracted from the video frame and subject to subsequent text recognition process. For example, the video frame can be cropped to isolate the portion of the bounding box from other irrelevant visual features that are not within the bounding box and/or not associated with the vehicle.

In one example, determination of the bounding box and detection of the vehicle within the bounding box are based on the feature map. In some embodiments, potential object regions at different scales and aspect ratios can be predicted by using a trained model using sliding window techniques. For example, predefined anchor boxes are placed at each location in the feature map to predict bounding boxes for different object sizes and shapes. Specialized convolutional filters are applied to the feature map to predict bounding box coordinates and object class scores for each anchor box. Bounding box regression can be used to refine the coordinates of the anchor boxes based on the detected features. Confidence scores are assigned to each predicted bounding box, and IoU scores are calculated for overlapping bounding boxes. NMS is applied to eliminate redundant bounding boxes and retain the bounding boxes having high confidence scores.

At 612, the isolated bounding box and recognized vehicle therein are further analyzed to detect/extract textual features in the bound box. For example, a text detection and recognition (OCR) model may be employed by the central server to extract the textual features. The detected textual features are also determined to be associated with the vehicle and represent an identity or attribute of the vehicle. In some embodiments, a region or location of a detected textual feature relative to the vehicle in the bounding box is determined, and whether the detected textual feature is associated with the vehicle and represents an identity or attribute of the vehicle is determined. For example, a number shown in a windshield of a bus within the bounding box is detected, the number is determined to be a bus number of the bus based on the feature map, and the value of the number is detected and identified. If multiple text regions are detected, each region may be processed individually. For example, a bus number is on the windshield, while a route number is on the side of the bus. Both the bus number and the route number are detected, their respective attributes of the bus are determined, and their respective values are identified. One or more trained models may be used, in conjunction with OCR model to detect/extract the textual features and determine their relationship/association with the vehicle and determine the attributes of the vehicle these textual features represent. The models may be an AI/ML model trained and developed with custom data (e.g., reference images of bus and bus number). Various character recognition and post-processing steps may be performed to refine and improve the extract text, including but not limited to, spell checking, language modeling, context analysis, error correction, etc.

At 614, a vehicle identity is determined based at least in part on the visual and text features associated with the vehicle. For example, an identity of a bus may be represented by the detected bus number and route number of the bus.

At 616, a status of the vehicle and a distance between the vehicle and the user are determined. For example, a status of a bus may include the available capacity of the bus, based on a visual feature that indicates the number of passengers visible through windows. The status of the bus may include the type of the bus, based on visual features indicating external markings, advertisements, or design elements. The status of the bus may further include an operational status, based on the visual features indicating headlights or destination board status. Additional information about the status of the bus may also be generated based on other visual features of the vehicle. The status of the bus may further indicate whether the vehicle is ready for boarding, based on visual features indicating that the vehicle stops, the vehicle door is open, and passengers are boarding. The distance between the vehicle and the user is also determined.

At 618, vehicle information for presentation to the user is determined based at least in part on the visual features, the identity of the vehicle, and the status of the vehicle. For example, the identity of the vehicle. For example, vehicle information such as the bus number, destination, available capacity, whether the bus is ready for boarding, etc., may be determined to have a higher priority and selected for presentation to the user. A reading order of the vehicle information may be determined based on their priority.

At 620, the selected vehicle information is presented to the user in an audio format. The vehicle information may be presented in the reading order.

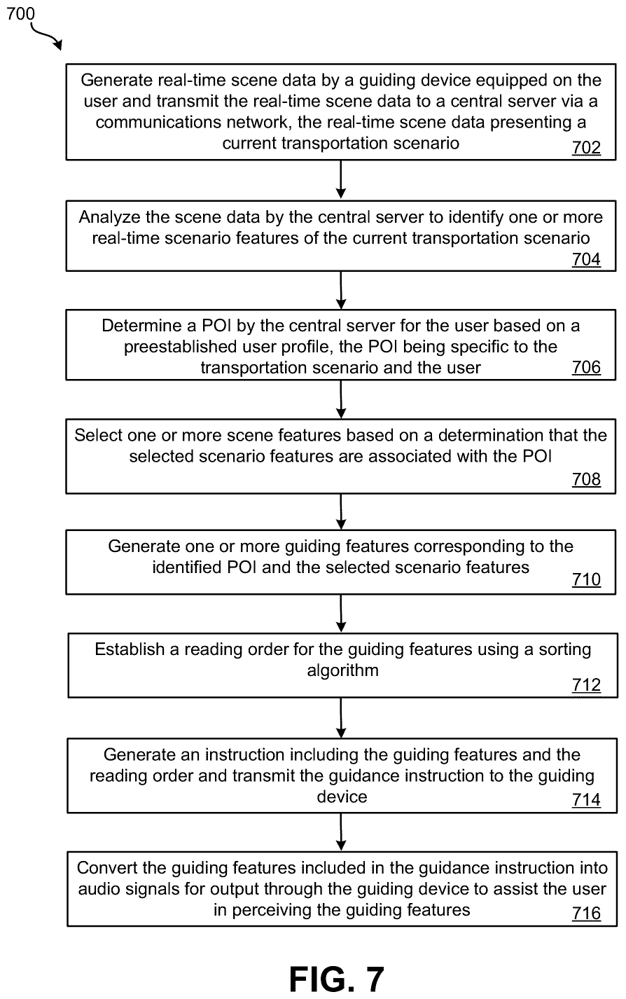

FIG. 7 is a flow diagram illustrating an example method 700 for provisioning transportation assistance and guidance to a user who is visually impaired, according to various embodiments. Method 700 may be performed by system 100A or 100B or service provisioning device 102 or 102′. Method 700 or any steps/operations thereof may be combined with other methods/processes or operations thereof described herein in a suitable manner.

At 702, real-time scene data is captured by a service provisioning device equipped on the user and transmitted to a central server via a communications network, the real-time scene data presenting a current transportation scenario. At 704, the scene data is analyzed by the central server to identify one or more real-time scenario features of the current transportation scenario. The one or more scenario features may include bus queue, approaching bus, bus identity (e.g., bus number, bus route, destination), bus type, bus occupancy level, bus available capacity, bus stop, boarding queen, and so on. In some embodiments, additional scenario features related to layout information of a transportation vehicle are identified, including information describing an arrangement of seats in the transportation vehicle and other visual features to assist the user in navigating once onboard. Pre-determined reference scenario features may be used to identify the real-time scenario features.

At 706, a POI is determined by the central server for the user based on the current location, a user intent (e.g., a planned destination), a specific user characteristic or user preference from a user profile, or a real-time user command transmitted from the service provisioning device. At 708, one or more scene features are selected based on a determination that the selected scenario features are associated with the POI. At 710, one or more guiding features corresponding to the identified POI and the selected scenario features are generated. The specific guiding features may include guidance on bus queueing, step-by-step boarding instructions, interior layout description, alert on upcoming stops, among others. At 712, a reading order is established for the selected scenario features and/or the guiding features using a sorting algorithm.

At 714, an instruction, including the scenario features, the guiding features, the additional layout information, the reading order, etc., is generated and transmitted to the service provisioning device for the user. At 716, the audio signals corresponding to the guiding features included in the guiding instruction are generated and provided to the user through a user output interface (e.g., an audio output interface) of the service provisioning device for the user to perceive.

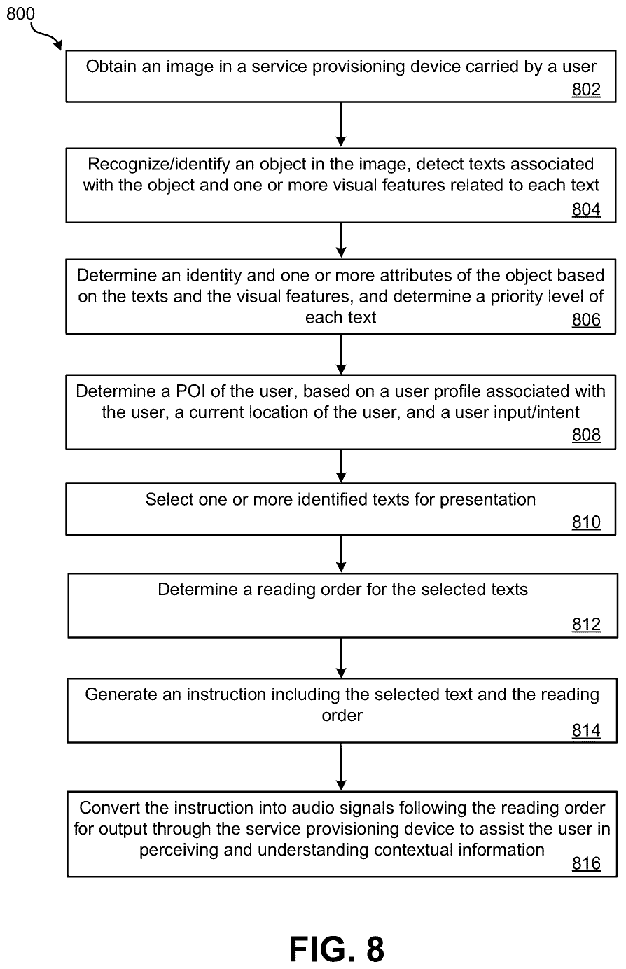

FIG. 8 is a flow diagram illustrating another example method 800 for provisioning guidance to a user having special need for the user to perceive an object in a current scene or environment surrounding the user, according to various embodiments. Method 800 may be performed by system 100A or 100B or service provisioning device 102 or 102′. Method 800 or any steps/operations thereof may be combined with other methods/processes or operations thereof described herein in a suitable manner.

At 802, a real-time image of a current scene surrounding the user is obtained in a service provisioning device carried by a user. At 804, an object is detected using object recognition, and one or more texts are detected, using text recognition modes. Bounding boxes may be used to identify the object. The texts are further determined to be associated with the object. In some embodiments, additional layout/location information about the text is identified, including sections, headings, paragraphs, and other visual features, based on the identified text within the image. For example, a location or region of a text within the image is determined, and the determination on whether the text is associated with the object is made based at least in part on the location or region (e.g. the position of the text relative to the object). In some embodiments, visual features of each text are also detected/extracted. The visual features represent one or more attributes of the text, such as size, color, font style, orientation, spacing, text length, clarity, sharpness, contrast, etc. In some embodiments, one or more semantic features of each text are also determined by at least one of part-of-speech tagging, named entity recognition (NER), dependency parsing, contextual analysis, and sentiment analysis.

At 806, an identity of the object and one or more attributes of the object are determined based at least in part on the visual features and/or semantic features related to the object as well as a predetermined priority rule. A trained model (e.g., AI/ML model) may be used to determine the identity and attributes of the object. The predetermined priority rule may be established based on the trained model with historical data. In some embodiments, the texts associated with the object are prioritized, and a priority level is determined for each one of the texts based on the visual features and/or the semantic features. For example, the text of a heading of a document (as a recognized object in the image) has a higher priority level than the text of a subtitle of the document. For a document, section titles are prioritized over the body text within the sections, and text that is highlighted or in bold is given higher priority. For a product, the brand name on a product label is given higher priority than the product description, and text indicating a promotion or discount is given higher priority. For a bus, the bus number is given higher priority than the route details.

At 808, a POI of the user is identified, based on at least one of a user profile associated with the user, a current location of the user, and a predicted user intent. At 810, one or more identified texts are selected for presentation, based on the identified POI of the user and/or the priority level of the texts. For example, a relevance to the POI for each one of the plurality of texts is determined, and the one or more texts for presentation are selected based on the relevance. At 812, a reading order is established for the selected texts, using a sorting algorithm. At 814, an instruction including the selected texts is generated and transmitted to the service provisioning device. At 816, the text included in the instruction is converted into audio signals for output through the service provisioning device following the reading order to assist the user in perceiving and understanding the object and contextual information.

In one example user case, system 100A or 100B or service provisioning device 102 or 102′ may be used to provide document reading assistance. Layout parsing and text detection techniques may be used to convert printed documents, such as books, magazines, or letters, into accessible formats for visually impaired users. This may involve identifying text, sections, headings, paragraphs, and visual features within the documents and further enable the user to access printed content that would otherwise be challenging to interpret. As another example, system 100A or 100B or service provisioning device 102 or 102′ may be used to provide guidance and assistance for visually impaired users during retail shopping activities. The service provisioning device could be used to read product labeling, packaging information, and nutrition labels aloud, and the central server could determine a product of interest and provide critical product details for the user, based on the identified POI and predicted user intent. This use case may enhance the shopping experience and empower the user to make informed choices. As another example, system 100A or 100B or service provisioning device 102 or 102′ may be used to recognize and interpret street signs, including street names, building numbers, public transportation information, and other relevant signage to assist users in navigating outdoor environments and improving their mobility and independence. As another example, system 100A or 100B or service provisioning device 102 or 102′ may be used to simplify the process of filling out forms and interacting with documents for users who are visually impaired. The system not only identifies text and visual features within forms but also determines the intelligent reading order for efficient interaction. This use case could streamline tasks that typically require visual comprehension and enhance accessibility and user productivity.

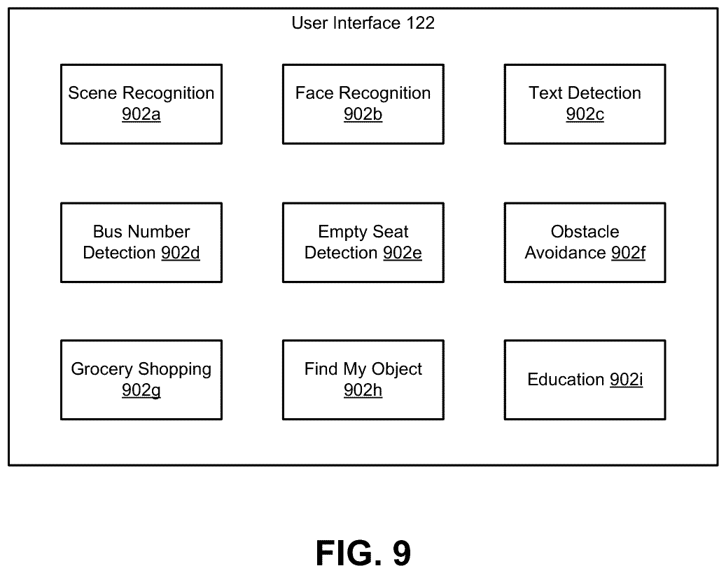

FIG. 9 illustrates an example user interface 122 of the service provisioning device 102, according to various embodiments of the present disclosure. In the illustrated examples, the user interface 122 is a graphical user interface, and multiple function modes 902 (e.g., in a form of virtual buttons) are displayed in the user interface 122 and visually presented to the user. For example, the function modes may include “text detection,” “bus number detection,” “empty seat detection,” “find an object,” and so on. The function modes may be scene-specific. The multiple function modes can be selected and activated by the user through user interaction with the application 120 executed on service provisioning device 102. For example, a user may click a virtual button to actuate a functional mode. In some embodiments, the various function modes are also presented to the user through an audio user interface. For example, a visually impaired user may activate the function mode by sending an audio command to the service provisioning device. In some embodiments, the service provisioning device 102 may automatically activate a function mode, upon detection of a scene relevant to a POI of the user. In some embodiments, the service provisioning device 102 may send a message (e.g., a text message or an audio message) to the user requesting for selecting a function mode for a user, and activate the function mode based on the user's selection. Multiple function modes may be activated sequentially or simultaneously.

The following non-limiting use cases further illustrate the examples of the implementation of system 100A or 100B or service provisioning device 102 or 102′ to provision services to the user in various scenarios.

In one example use case, a user arrives at the bus stop and activates his service provisioning device in a “Text Detection” mode 902c, when pointed at a bus stop sign, and the service provisioning device detects the text on the bus stop sign and reads aloud the bus route information and upcoming arrival times for a bus. The user then activates the “Bus Number Detection” mode 902d to scan and identify the incoming buses and the destination. This information is relayed to the user using audio outputs from the service provisioning device. The user verifies the information and waits for the correct bus to board. Once boarded the “Empty Seat Detection” mode 902e is activated to find seats for the user to occupy. After arriving at the destination, the user changes to “Scene Recognition” mode 902a to explore the neighborhood. The service provisioning device captures images of various landmarks, such as shops, parks, and street signs, describes each location, and provides information about nearby amenities and POIs. As the user walks through a street and a road cross, the “Obstacle avoidance” mode 902f can be activated for navigation.

In another example use case, a user plans to go shopping at a nearby grocery store. When the user enters the grocery store, the “Grocery Shopping” mode 902g is activated. The service provisioning device identifies different aisles and help the user navigate to the preferred aisle by providing the spatial information (distance and position) of the aisle. As the user reaches the preferred aisle, the device identifies different objects in the rack, by pointing at it and taking pictures. The user can use the “Text Detection” mode 902c to read the labels, nutritional values, price and other information on the product/object. The service provisioning device can also make personalized product recommendations based on the user's shopping history, dietary preferences and allergies which are stored in a user profile accessible by the service provisioning device. The service provisioning device can also provide information about any offers or discounts running in the store or any of their preferred items running on sale. This empowers the user to make informed choices without human assistance. In a scenario where the user is looking for a particular product like milk or cookie in a rack, the user can switch to “Find my Object” mode 902h to input the object they are looking for and the label of the object and ask the service provisioning device to locate the object (e.g., the position and rack number).

In another example use case, a visually impaired user is attending a social gathering. As the user enters the place, the user wants to know what is happening, and the “Scene Recognition” mode 902a can be activated to determine and present a general description of the place and scenario. The user wants to know whether there is any familiar person in the crowd, and the “Face Recognition” mode 902b can be activated to scan the crowd and identify familiar faces of friends and family members, based on the reference pictures of the friends or family members accessible by the service provisioning device. The service provisioning device can present the identity of the identified person along with some personal information (e.g., John, a school friend) and spatial information of the identified person to the user, so that the user can go and interact with them.

In another example use case, a user decides to have a meal at a restaurant either alone or with friends. The user enters a restaurant, activates the “Scene Recognition” mode 902a to understand the scene in the restaurant. If the user is dining alone, the “Empty Seat Detection” mode 902e can be activated to identify available seats (position and distance) to occupy. If the user is meeting up with their friends/family for a meal, the “Face Recognition” mode 902b can be activated to scan the restaurant and identify where their friends are sitting and present this information to the user. After occupying a place, the user can activate “Text Detection” mode 902c to read aloud the menu items and descriptions, allowing the user to independently choose a meal. Additionally, the service provisioning device can provide recommendations from the menu based on the user's dietary preferences and allergies.

In another example use case, a user carries a service provisioning device during nature walking/hiking. The user activates the “Scene Recognition” mode 902a on the device. The device captures images of the surrounding landscape, identifying trees, plants, and wildlife along the trail. The device describes the natural features, including the types of trees and the sounds of birds chirping. When the user encounters obstacles such as fallen branches or uneven terrain, the device provides audio cues to help them navigate safely. Additionally, the device can provide educational information about the ecosystem and conservation efforts in the area.

In another example use case, a user is visiting a museum with his school class. The user activates his service provisioning device in “Educational Mode” specifically designed for museums and historical sites. As the user approaches an exhibit, the device scans the surroundings and identifies the object or artwork and delivers a detailed, age-appropriate description. The device can provide additional information, such as historical context, interesting facts, etc., for which the user can ask follow-up questions through audio commands to get clear and engaging answers. This can provide the user with an interactive and personalized experience.

In another example use case, a user explores an amusement park for leisure. As the user reaches the desired amusement park, an “Adventure” mode of the service provisioning device specifically designed for amusement park exploration and entertainment is activated. The “Adventure” mode utilizes GPS and location-based services to identify the current location of the user within the amusement park. The device provides a map of the park and highlights nearby attractions, rides, and shows, along with relevant wait times and descriptions. The user can ask the device for recommendations based on the user's preferences, such as thrill rides, water attractions, or family-friendly options. The device can also provide real-time updates on show schedules, parade routes, and special events happening throughout the day. Additionally, the device can provide navigation assistance within the park, guiding users to their desired destinations or helping them locate amenities such as restrooms, food stalls, or first aid stations. In case of an emergency or if the user gets separated from their group, an “SOS” mode of the device can be activated to alert park staff or contact the designated emergency contacts of the user.

In another example use case, a user decides to cook a meal. The user decides what they want to cook and input that information to the device. The device lists down the ingredients needed and the recipe to follow along. The users can activate the “Object +Text Detection” mode of the device to identify ingredients needed. The device can guide the user through the recipe by capturing images and analyzing ingredients in the pan using the “Scene Recognition” mode 902a, during each stage of the cooking process.

In another example use case, an elderly patient lives alone. The service provisioning device provides an “SOS” function, which can be activated by the user for any kind of emergency assistance. The device can ask a series of questions through voice prompts, to understand the situation. The device can automatically activate the “Scene Recognition” mode 902a to determine the emergency situation and automatically contacts emergency services, or friends or family of the user. The device can connect the user with a dispatcher and relay their location and potential injuries, allowing them to speak directly for further assistance. In addition, the device can automatically send a notification along with live video streaming to the family members registered in the device. This real-time visual information helps them make informed decisions about the level of assistance required.

The service provisioning device can allow the user to set a virtual boundary around the living place of the user using geo-fencing. If the user wearing the device crosses this virtual boundary, the device detects this change in location and sends an alert to the registered family member or caregiver to receive notification along with the location of the live place of the user. The device can also include fall detection sensors that can detect sudden movements or impacts associated with a fall. If the device detects a fall, it immediately activates a “Fall Detection” mode and sends an alert to the registered emergency contacts (family member or caregivers) along with the user's location information. The device then allows the user's emergency contacts to initiate voice calls with the elderly user and/or the registered emergency contacts.

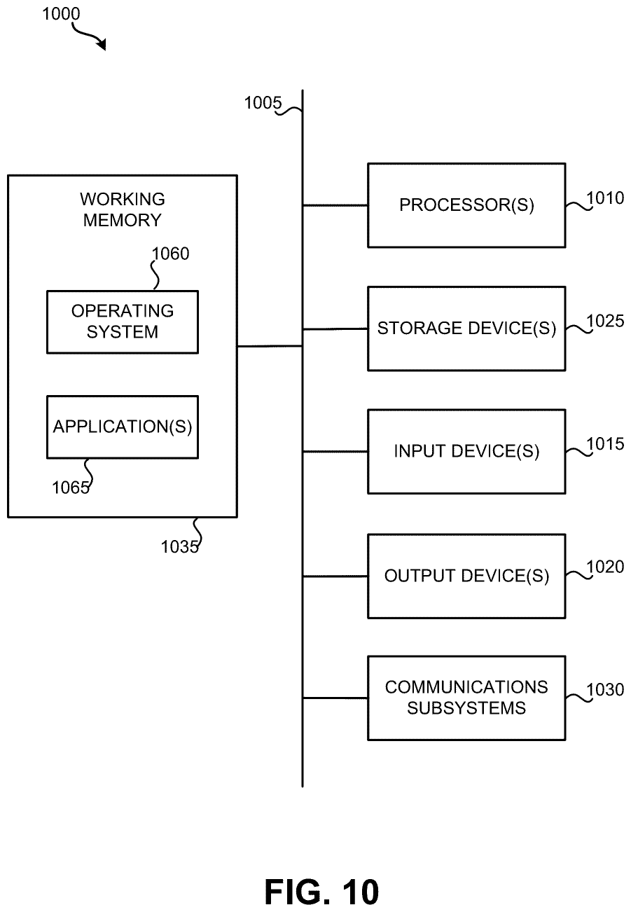

The systems 100A and 100B, or any components thereof, such as the service provisioning device 102 or 102′ and central server 104, described above may include a computer system that further includes computer hardware and software that form special-purpose network circuitry to implement various embodiments such as communication, detection, recognition, determination, identification, calculation, and other operations or steps of the methods or processes described herein. FIG. 10 is a schematic diagram illustrating an example of computer system 1000. The computer system 1000 is a simplified computer system that can be used to implement various embodiments described and illustrated herein. FIG. 10 provides a schematic illustration of one embodiment of a computer system 1000 that can perform some or all of the steps of the methods and workflows provided by various embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

The computer system 1000 is shown including hardware elements that can be electrically coupled via a bus 1005, or may otherwise be in communication, as appropriate. The hardware elements may include one or more processors 1010, including without limitation one or more general-purpose processors and/or one or more special-purpose processors such as digital signal processing chips, graphics acceleration processors, and/or the like; one or more input devices 1015, which can include without limitation a mouse, a keyboard, a camera, and/or the like; and one or more output devices 1020, which can include without limitation a display device, a printer, and/or the like.

The computer system 1000 may further include and/or be in communication with one or more non-transitory storage devices 1025, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 1000 might also include a communications subsystem 1030, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 1030 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 1030. In other embodiments, a portable electronic device, e.g., the first electronic device, may be incorporated into the computer system 1000, e.g., an electronic device as an input device 1015. In some embodiments, the computer system 1000 will further include a working memory 1035, which can include a RAM or ROM device, as described above.

The computer system 1000 also can include software elements, shown as being currently located within the working memory 1035, including an operating system 1060, device drivers, executable libraries, and/or other code, such as one or more application programs 1065, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 10, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1025 described above. In some cases, the storage medium might be incorporated within a computer system, such as computer system 1000. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 1000 and/or might take the form of source and/or installable code, which, upon compilation and/or installation on the computer system 1000 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 1000 to perform methods in accordance with various embodiments of the technology. According to a set of embodiments, some or all of the operations of such methods are performed by the computer system 1000 in response to processor 1010 executing one or more sequences of one or more instructions, which might be incorporated into the operating system 1060 and/or other code, such as an application program 1065, contained in the working memory 1035. Such instructions may be read into the working memory 1035 from another computer-readable medium, such as one or more of the storage device(s) 1025. Merely by way of example, execution of the sequences of instructions contained in the working memory 1035 might cause the processor(s) 1010 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 1000, various computer-readable media might be involved in providing instructions/code to processor(s) 1010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1025. Volatile media include, without limitation, dynamic memory, such as the working memory 1035.

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000.

The communications subsystem 1030 and/or components thereof generally will receive signals, and the bus 1005 then might carry the signals and/or the data, instructions, etc. carried by the signals to the working memory 1035, from which the processor(s) 1010 retrieves and executes the instructions. The instructions received by the working memory 1035 may optionally be stored on a non-transitory storage device 1025 either before or after execution by the processor(s) 1010.

The various algorithms presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a feature” includes a plurality of such features, and reference to “the processor” includes reference to one or more processors and equivalents thereof known in the art, and so forth.

Also, the words “comprise”, “comprising”, “contains”, “containing”,

“include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications,

alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method, performed by a user device, the method comprising:
obtaining an image of a current scene surrounding the user;
identifying an object in the image;
detecting a plurality of texts associated with the object;
detecting a plurality of visual features and semantic features related to the text;
determining an identity of the object and one or more attributes of the object based at least in part on the visual features and the semantic features;
selecting one or more texts for presentation from the plurality of texts; and
presenting the selected texts in an audio form to the user to allow the user to perceive the identity and one or more attributes of the object.

2. The method of claim 1, further comprising:
determining a point of interest (POI) of the user, based on at least one of a user profile associated with the user, a current location of the user, and a user input; and
determining that the identified object is associated with the POI of the user.

3. The method of claim 2, further comprising:
determining a relevance level to the POI for each one of the plurality of texts,
wherein the one or more texts for presentation are selected based on the relevance level.

4. The method of claim 1, further comprising:
determining an object of interest for the user; and
determining that the identified object is the object of interest, before detecting the texts and visual features.

5. The method of claim 1, further comprising:
determining a priority level for each one of the texts associated with the object, based at least in part on the visual features and semantic features related to the text,
wherein the one or more texts for presentation are selected based on the priority levels of the texts.

6. The method of claim 1, further comprising:
determining a reading order for the one or more texts,
wherein the one or more texts are presented to the user following the reading order.

7. The method of claim 1, further comprising:
determining a distance between the object and the user,
presenting the distance to the user in an audio form.

8. A user device comprising:
one or more processors; and
a computer-readable storage media storing computer-executable instructions that, when executed by the one or more processors, cause the user device to:
obtain an image of a current scene surrounding the user;
identify an object in the image;
detect a plurality of texts associated with the object;
detect a plurality of visual features and semantic features related to the text;
determine an identity of the object and one or more attributes of the object based at least in part on the visual features and the semantic features;
select one or more texts for presentation from the plurality of texts; and
present the selected texts in an audio form to the user to allow the user to perceive the identity and one or more attributes of the object.

9. The user device of claim 8, wherein, the instructions when executed by the one or more processors further cause the user device to:
determine a point of interest (POI) of the user, based on at least one of a user profile associated with the user, a current location of the user, and a user input; and
determine that the identified object is associated with the POI of the user.

10. The user device of claim 9, wherein, the instructions when executed by the one or more processors further cause the user device to:
determine a relevance level to the POI for each one of the plurality of texts,
wherein the one or more texts for presentation are selected based on the relevance level.

11. The user device of claim 8, wherein, the instructions when executed by the one or more processors further cause the user device to:
determine an object of interest for the user; and
determine that the identified object is the object of interest, before detecting the texts and visual features.

12. The user device of claim 8, wherein, the instructions when executed by the one or more processors further cause the user device to:
determine a priority level for each one of the texts associated with the object, based at least in part on the visual features and semantic features related to the text,
wherein the one or more texts for presentation are selected based on the priority levels of the texts.

13. The user device of claim 8, wherein, the instructions when executed by the one or more processors further cause the user device to:
determine a reading order for the one or more texts,
wherein the one or more texts are presented to the user following the reading order.

14. The user device of claim 8, wherein, the instructions when executed by the one or more processors further cause the user device to:
determine a distance between the object and the user,
present the distance to the user in an audio form.

15. A system comprising:
a user device; and
a central server in communication with the user device via a network;
wherein the user device is configured to:
obtain an image of a current scene surrounding the user; and
transmit the image to the central server,
wherein the central server is configured to:
identify an object in the image;
detect a plurality of texts associated with the object;
detect a plurality of visual features and semantic features related to the text;
determine an identity of the object and one or more attributes of the object based at least in part on the visual features and the semantic features;
select one or more texts for presentation from the plurality of texts; and
transmit the selected texts to the user device;
wherein the user device is further configured to:
present the selected texts in an audio form to the user.

16. The system of claim 15, wherein the central server is further configured to:
determine a point of interest (POI) of the user, based on at least one of a user profile associated with the user, a current location of the user, and a user input; and
determine that the identified object is associated with the POI of the user.

17. The system of claim 16, wherein the central server is further configured to:
determine a relevance level to the POI for each one of the plurality of texts,
wherein the one or more texts for presentation are selected based on the relevance level.

18. The system of claim 15, wherein the user device is further configured to:
determine an object of interest for the user; and
determine that the identified object is the object of interest, before detecting the texts and visual features.

19. The user device of claim 15, wherein the central server is further configured to:
determine a priority level for each one of the texts associated with the object, based at least in part on the visual features and semantic features related to the text,
wherein the one or more texts for presentation are selected based on the priority levels of the texts.

20. The user device of claim 15, wherein the central server is further configured to:
determine a reading order for the one or more texts,
wherein the one or more texts are presented to the user following the reading order.
